(19) United States
(12) Patent Application Publication
(10) Pub. No.: US 2011/0167729 A1
(43) Pub. Date: Jul. 14, 2011

(54) MODULAR MOUNT FOR HANDLING DOOR WITH FLEXIBLE SCREEN

(75) Inventors: Anne-Sophie Panseri, Montanay (FR); Antonello La Marca, Corbas (FR); Romain Simon, Caluire (FR)

(73) Assignee: MAVIFLEX, Decines Charpieu (FR)

(21) Appl. No.: 12/668,071

(22) PCT Filed: Jul. 11, 2008
(86) PCT No.: PCT/FR08/01016

§ 371 Date: Jul. 22, 2010

(30) Foreign Application Priority Data
Jul. 12, 2007 (FR) 07 05050

(51) Int. Cl. E05D 15/38

(52) U.S. Cl. 49/199

(57) ABSTRACT

A vertical modular mount for a handling door (1) includes an upper plate (18) connected to a horizontal frame (4) and more particularly to a side flange (19), a lower plate (20) connected to the ground, a central web (21) connecting the upper (18) and lower (20) plates together, a cloth (23) arranged around the upper (18) and lower (20) plates in order to define an envelope (24) on the entire height of the mount (2, 3), and a guiding device (15) defining a slide for the movement of the flexible screen (6), characterized in that each of the members (21, 23, 15) forming the mounts (2, 3) of the handling door (1) are arranged so as to impart a high resilience to the latter, i.e. a high resistance to shocks due to the elastic deformation of each of the members.

The present invention relates to a modular upright for curtain-type service doors for buildings and more particularly to opposite vertical uprights fastened to a guide device or slide for guiding the flexible curtain when it moves between an open position and a closed position.

Vertical uprights are known in the art that consist of bent sheet metal slides, drawn aluminum slides or extruded plastic material slides.

By virtue of their structure and their shape these slides can also constitute the vertical uprights of a service door of the flexible curtain type.

These slides are generally produced in one part or at most two parts and have certain drawbacks in that they are exposed to impact with the risk of irreparable damage necessitating complete replacement.

There are also known from the applicant's patent No. EP 0979340 vertical service door uprights including taut flexible slides on a bent sheet metal structural section.

The modular service door upright of the present invention consists of a number of combined structural elements that are produced in different materials to provide total resilience and flexibility in order to be able to absorb impacts without risk of damaging said structural elements.

The modular service door vertical upright of the invention includes an upper plate fastened to the horizontal box section and more particularly to the lateral flange, a lower plate fixed to the ground, a central core connecting the upper plate and the lower plate together, a cloth fixed around the upper plate and the lower plate in order to constitute over the full height of the upright an envelope, and a guiding device constituting a slide for movement of the flexible curtain, and in that each element constituting the upright of the service door is adapted to make it very resilient, i.e. highly resistant to impact, because of the elastic deformation of each of its elements.

The service door modular vertical upright of the present invention has other essential features that are described in and protected by the secondary claims dependent directly or indirectly on the main claim.

The appended drawings, provided by way of example, explain the invention, its features and the advantages that it can procure:

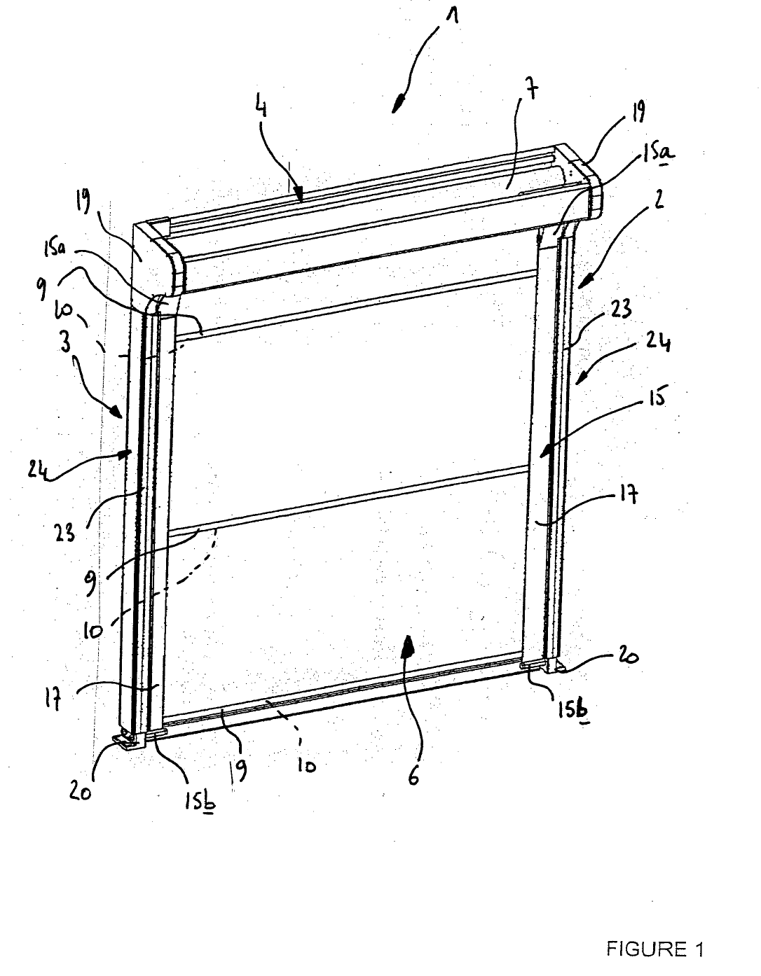

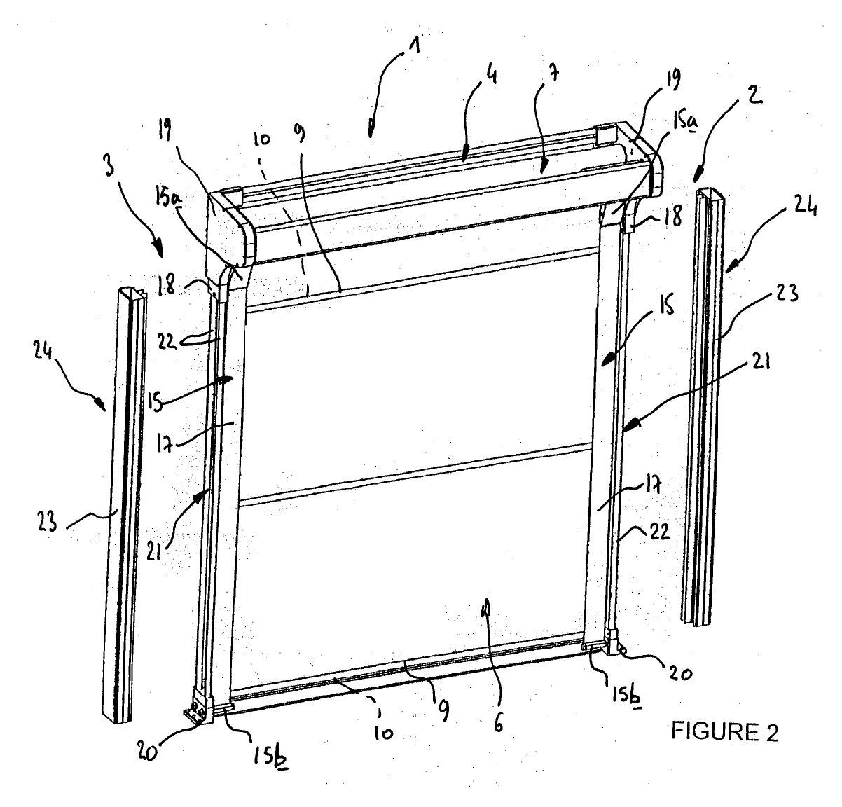

FIGS. 1 and 2 are perspective views showing a service door including modular uprights of the present invention.

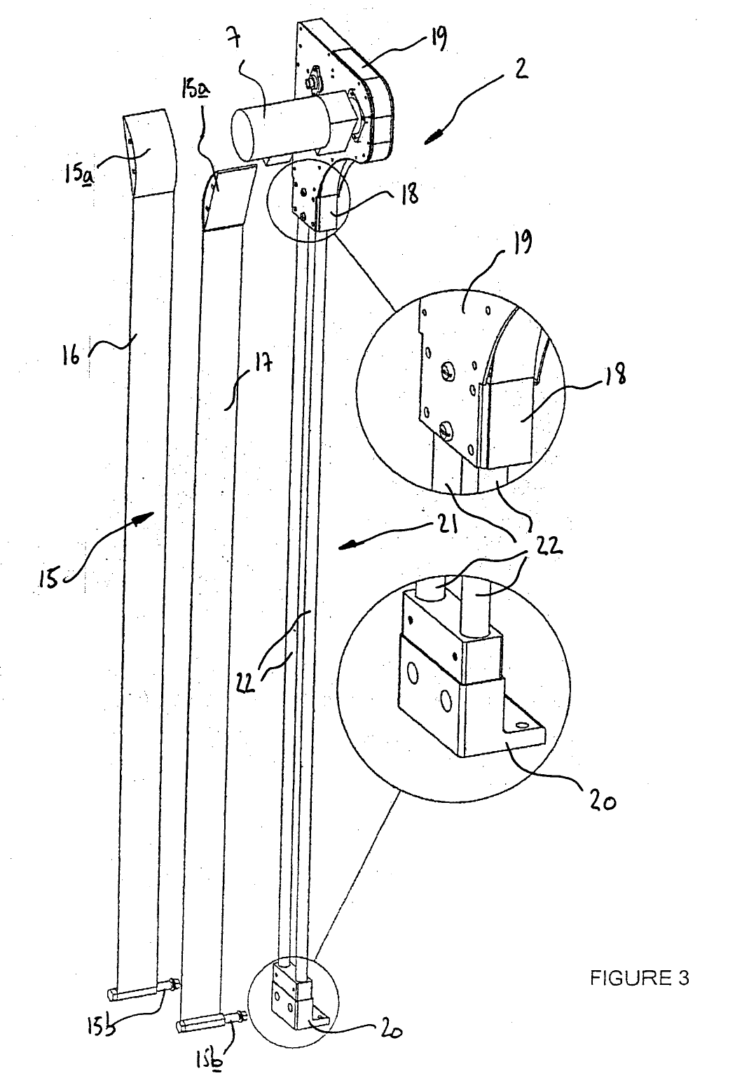

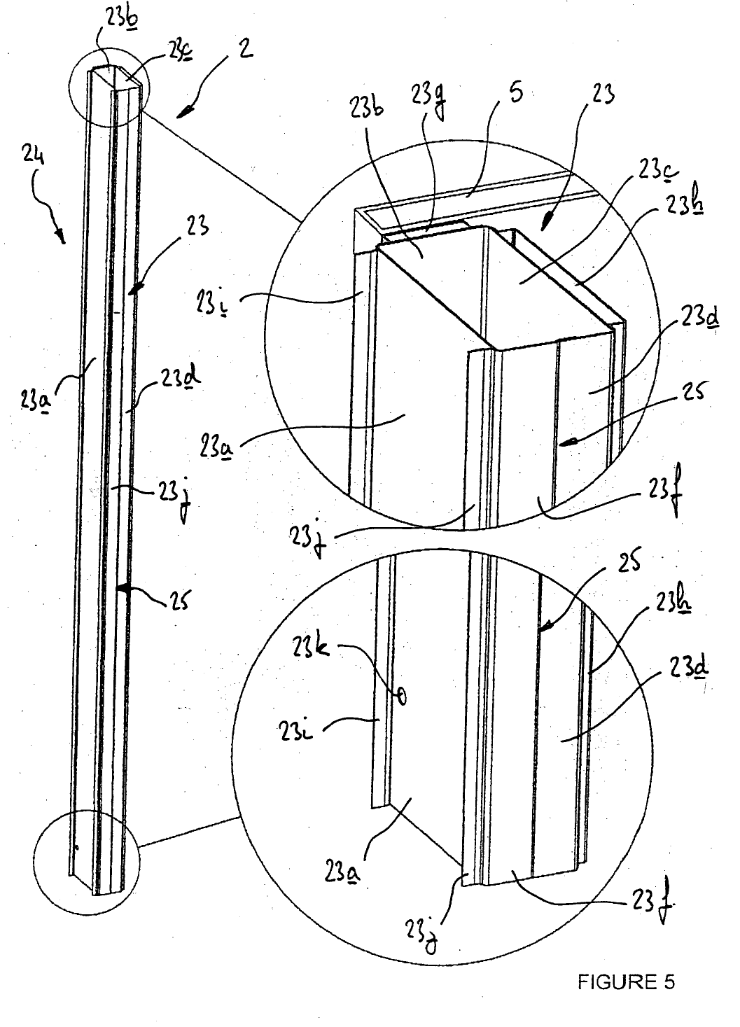

FIGS. 3 to 6 are perspective views representing in detail the structural elements constituting each service door modular upright of the present invention.

There is shown in FIGS. 1 and 2, by way of example, a service door 1 for industrial buildings including two opposite modular lateral uprights 2 and 3 connected together at the top by a horizontal box section 4. The modular lateral uprights 2 and 3 can be fixed or not at a certain distance from the face 5 of a wall, depending on the function of the service door 1.

In this example, the service door 1 is a roller door including in the horizontal box section 4 connecting the modular uprights 2 and 3 together a driving drum 7 for rolling and unrolling a flexible curtain 6 between an open position and a closed position.

The flexible curtain 6 includes sheaths 9 each of which receives inside it horizontal reinforcement crossmembers 10.

Each modular vertical upright 2, 3 includes a guiding device 15 for guiding the flexible curtain 6 and the horizontal reinforcement crossmembers 10 during vertical movement of said curtain between an open position and a closed position.

For example, the guiding device 15 provided on each modular upright 2, 3 can consist either of two taut straps 16, 17 or of two semi-rigid slats disposed face-to-face as described in the applicant's patents EP 0979340 and EP 1248892.

There are represented in FIGS. 3 to 6 the structural elements constituting the modular vertical upright 2 of the service door 1, the other modular vertical upright 3 being of identical construction.

Thus the modular upright 2 consists of an upper plate 18 fastened to the horizontal box section 4 and more particularly a lateral flange 19 for retaining the driving drum 7 of the service door 1 and guiding its rotation. The upper plate 18 is below and in line with the lateral flange 19 so as to face the ground in the opening receiving the service door 1.

The modular upright 2 includes a lower plate 20 with the same profile as the upper plate 18 which is fixed to the ground in the opening in which the service door 1 is to be installed.

The modular upright 2 includes a central core 21 connecting together the upper plate 18 and the lower plate 20. The central core 21 can consist of at least one tubular vertical structural section 22 produced for example in a composite or plastic material or in steel with a high elastic limit offering good deformation characteristics so that it can return to its original position after an impact.

The central core 21 can consist of two or four tubular structural sections 22, for example.

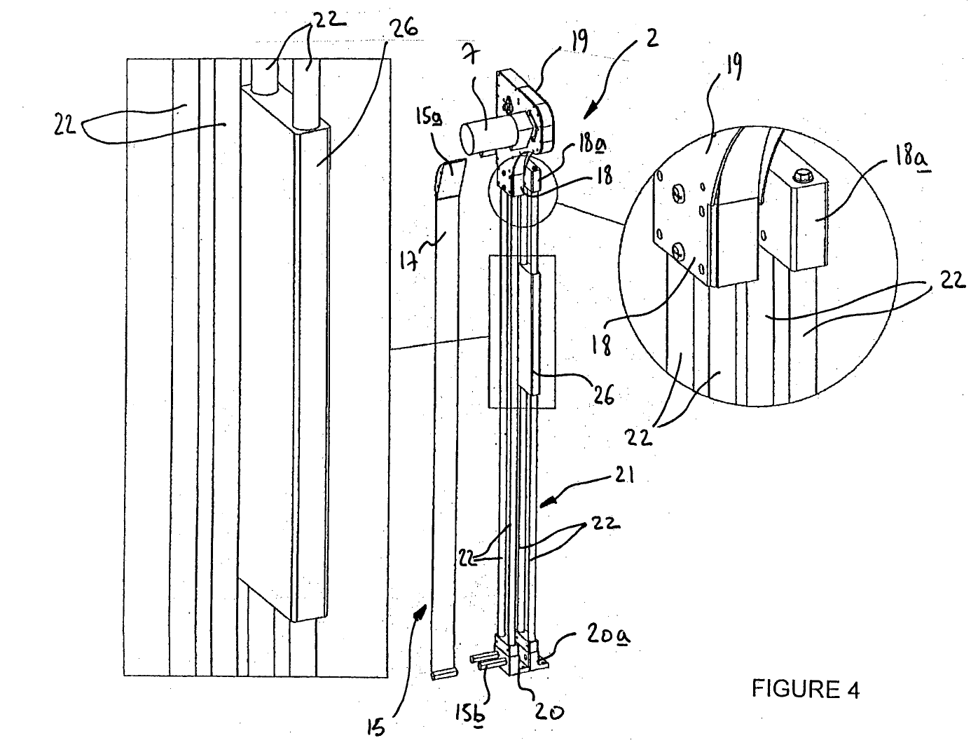

If the central core 21 consists of four tubular structural sections 22, for example, the first two tubular structural sections 22 are fixed between the upper plate 18 and the lower plate 20 and the other two tubular structural sections 22 are retained between two other plates, namely an upper plate 18a and a lower plate 20a, producing a framework for guiding and housing a counterweight 26 in a manner appropriate to the structure of the service door 1 (FIG. 4).

The modular vertical upright 2 includes a guiding device 15 consisting of two taut straps 16, 17 fixed in the upper plate 18 and the lower plate 20. Each taut strap 16, 17 includes in its upper portion an inclined shoe 15a fastened to the upper plate 18. The straps 16, 17 are fixed to the lower plate 20 by a tensioner 15b that can be rotated to adjust the tautness of said straps.

The modular upright 2 includes a cloth 23 that is produced in a single-skin or double-skin technical fabric similar to that used for the flexible curtain 6 and fastened around the upper plate 18 and the lower plate 20 to constitute over the full height of said upright an envelope 24 having an external profile similar to that of said plates 18, 20. The envelope 24 can also cover the upper plates 18, 18a and lower plates 20, 20a if the modular upright 2 includes a central core 21 consisting of four parallel tubular structural sections 22.

The envelope 24 consists of a cloth 23 with cloth panels 23a, 23b, 23c, 23d arranged and fixed, for example welded, together to follow the dimensions and external contour of the upper plate 18 and the lower plate 20 to cover the latter and the central core 21 of the modular upright 2.

The cloth panel 23d of the envelope 24 is slit over its full height to form two half-panels 23e, 23f to delimit an entry for fitting said envelope 24 around the upper plate 18 and the lower plate 20.

The two half-panels 23e, 23f are connected together by closure means 25 of the zip, popper, Velcro type to retain the envelope 24 around the upper plate 18 and the lower plate 20.

Facing the cloth panel 23d is the cloth panel 23b of the envelope 24 that is intended to come to bear against the face 5 of the wall receiving the service door 1. The cloth panel 23b has on its external face and over its full height a bead 23g that bears against the face 5 of the wall in order to provide a seal therewith.

The larger cloth panels 23a, 23c are perpendicular to the cloth panel 23d of the envelope 24. The cloth panel 23c has on its external face and over its full height a housing 23h through which electrical cables can be passed, for example.

The cloth panel 23a has on its external face and over its full height tongues 23i, 23j disposed in the vicinity of the areas of connection with the cloth panels 23b and 23d, respectively, of the envelope 24. The tongues 23i and 23j provide a lateral seal when they are in contact with the corresponding taut straps 16, 17 of the guiding device 15.

The cloth panel 23a can equally include in its lower portion at least one opening 23k, not shown, for security cells.

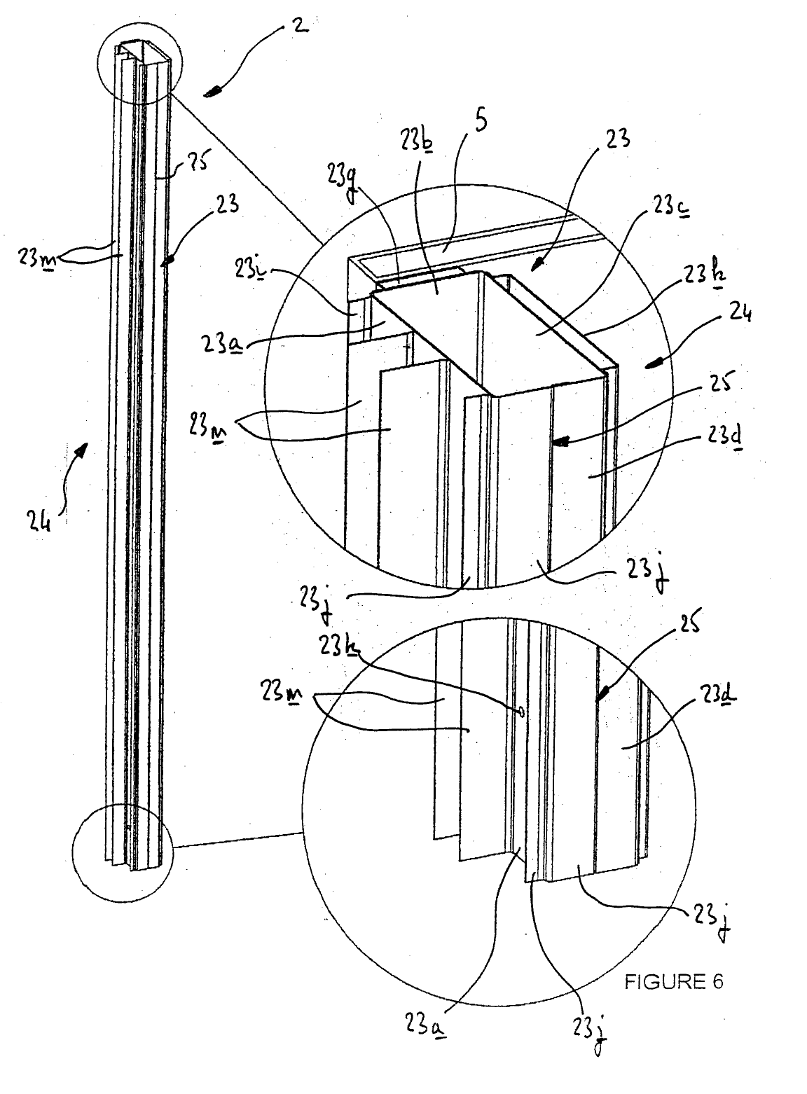

The cloth panel 23a can equally include in the middle and over its full height one or two other central tongues 23m providing a lateral seal when they are in contact with the edges of the flexible curtain 6 of the service door when it moves between an open position and a closed position. In this case, the cloth panel 23a can include in its lower portion and between the tongues 23i, 23j and the central tongues 23m at least one opening 23k for security cells that are not shown (FIG. 6).

The envelope 24 can consist of a cloth 23 produced from a double-skin fabric solving the problems of heat exchange and icing up if the service door 1 is installed in a cold room.

The envelope 24 can equally consist of a cloth 23 produced from an ATEX class fabric enabling use of the service door 1 in areas where there is a risk of explosion.

The envelope 24 can equally consist of a cloth 23 produced from an Mo, M1 or M2 class fabric enabling use of the service door 1 in areas where there is a risk of fire.

Thus the structure of the vertical uprights 2, 3 means that they are quick to install and reduces their weight.

Note that the envelope 24 of each modular upright 2, 3 can be produced in a cloth 23 that is of exactly the same color as that used for the flexible curtain 6.

It is found that the structure consisting of the assembly of elements constituting each upright 2, 3 of the service door 1 makes it very resilient, i.e. highly resistant to impact, because of the elastic deformation of each of its elements.

It must furthermore be understood that the foregoing description has been given by way of example only and that it is in no way limiting on the scope of the invention, which would not be exceeded by replacing the details of execution described by any equivalent other such details.

1. Modular vertical upright for service door (1), said service door including a horizontal box section (4) provided with lateral flanges (19) for retaining a driving drum (7) and guiding its rotation during movement between an open position and a closed position of a flexible curtain (6), characterized in that it includes an upper plate (18) fastened to the horizontal box section (4) and more particularly to the lateral flange (19), a lower plate (20) fixed to the ground, a central core (21) connecting the upper plate (18) and the lower plate (20) together, a cloth (23) fixed around the upper plate (18) and the lower plate (20) in order to constitute over the full height of the upright (2, 3) an envelope (24), and a guiding device (15) constituting a slide for movement of the flexible curtain (6), and in that each element (21, 23, 15) constituting the upright (2, 3) of the service door (1) is adapted to make it very resilient, i.e. highly resistant to impact, because of the elastic deformation of each of its elements.

2. Modular vertical upright according to claim 1, characterized in that the central core (21) consists of at least one tubular vertical structural section (22) produced in a composite or plastic material of high elasticity or in steel with a high elastic limit.

3. Modular vertical upright according to claim 1, characterized in that the central core (21) consists of four tubular structural sections (22) that are parallel in pairs, the first two tubular structural sections (22) whereof produce the framework of the vertical upright (2, 3) while the other two tubular structural sections (22) guide and house a counterweight (26).

4. Modular vertical upright according to claim 1, characterized in that the cloth (24) is produced in a single-skin or double-skin technical fabric similar to that used for the flexible curtain (6).

5. Modular vertical upright according to claim 1, characterized in that the envelope (24) consists of a cloth (23) with cloth panels (23a, 23b, 23c, 23d) arranged and fixed together by welding to follow the dimensions and the external contour of the upper plate (18) and the lower plate (20) so as to cover them and the central core (21) of the modular upright (2, 3).

6. Modular vertical upright according to claim 5, characterized in that the cloth panel (23d) is slit over its full height to form two half-panels (23e, 23f) for delimiting an entry for fitting the envelope (24) formed of the cloth (23) around the upper plate (18) and the lower plate (20).

7. Modular vertical upright according to claim 6, characterized in that the two half-panels (23e, 23f) are connected together by closure means (25) for retaining the envelope (24) around the upper plate (18) and the lower plate (20).

8. Modular vertical upright according to claim 5, characterized in that the cloth panel (23b) has on its external face and over its full height a bead (23g) providing a seal with the face (5) of the wall.

9. Modular vertical upright according to claim 5, characterized in that the cloth panel (23c) has on its external face and over its full height a housing (23h) through which electrical cables can be passed.

10. Modular vertical upright according to claim 5, characterized in that the cloth panel (23a) has on its external face and over its full height tongues (23i, 23j) disposed in the vicinity of the connecting areas with the cloth panels (23b, 23d), respectively, in order to provide a lateral seal when they are in contact with the taut straps (16, 17) of the guiding device (15).

11. Modular vertical upright according to claim 10, characterized in that the cloth panel (23a) has in its middle and over its full height one or two other central tongues (23m) providing a lateral seal when they are in contact with the edges of the flexible curtain (6) of the service door (1).

12. Modular vertical upright according to claim 11, characterized in that the cloth panel (23a) has in its lower portion and between the tongues (23i, 23j) and the central tongues (23m) at least one opening (23k) through which security cells, not shown, can pass.
